(19) United States
(12) Patent Application Publication
(10) Pub. No.: US 2024/0410534 A1
(43) Pub. Date: Dec. 12, 2024

(54) DETECTING ABNORMALITIES IN FLANGES USING EMBEDDED DEVICES AND TINY MACHINE LEARNING

(71) Applicant: Saudi Arabian Oil Company, Dhahran (SA)

(72) Inventors: Ali Alrasheed, Thuwal (SA); Amjad Felemban, Thuwal (SA); Raed Samanoodi, Thuwal (SA); Hassane Trigui, Jeddah (SA); Sahejad Patel, Thuwal (SA); Siddharth Mishra, Dhahran (SA)

(21) Appl. No.: 18/333,068

(22) Filed: Jun. 12, 2023

(51) Int. Cl. F17D 5/06; F16L 23/024

(52) U.S. Cl. CPC F17D 5/06; F16L 23/024; F16L 2201/10

(57) ABSTRACT

A computer-implemented method for detection of abnormalities in flanges using embedded devices and tiny machine learning is described. The method includes obtaining sensor data associated with at least one flange, wherein the sensor data is captured by at least one sensor communicatively coupled with an embedded device on a mesh network. The method also includes executing a trained tiny machine learning model at the embedded device, wherein the sensor data is input to the trained tiny machine learning model and the trained tiny machine learning model predicts a state of the at least one flange. Additionally, the method includes transmitting the state to a master node across the mesh network, wherein further actions are performed responsive to the state of the at least one flange.

### TECHNICAL FIELD

This disclosure relates generally to flange abnormality detection.

### BACKGROUND

Flanges include projecting collars that are physically coupled to seal a pressurized vessel or pipe. Multiple flanges are used in a pipeline. Standards applicable to flanges are promulgated by organizations such as the American Society of Mechanical Engineers (ASME) and American National Standards Institute (ANSI).

### SUMMARY

An embodiment described herein provides a method for detection of flange abnormalities. The method includes obtaining, with one or more hardware processors, sensor data associated with at least one flange, wherein the sensor data is captured by at least one sensor communicatively coupled with an embedded device on a mesh network. The method includes executing, with the one or more hardware processors, a trained tiny machine learning model at the embedded device, wherein the sensor data is input to the trained tiny machine learning model and the trained tiny machine learning model predicts a state of the at least one flange. The method includes transmitting, with the one or more hardware processors, the state to a master node across the mesh network, wherein further actions are performed responsive to the state of the at least one flange.

An embodiment described herein provides an apparatus comprising a non-transitory, computer readable, storage medium that stores instructions that, when executed by at least one processor, cause the at least one processor to perform operations. The operations include obtaining sensor data associated with at least one flange, wherein the sensor data is captured by at least one sensor communicatively coupled with an embedded device on a mesh network. The operations include executing a trained tiny machine learning model at the embedded device, wherein the sensor data is input to the trained tiny machine learning model and the trained tiny machine learning model predicts a state of the at least one flange. The operations include transmitting the state to a master node across the mesh network, wherein further actions are performed responsive to the state of the at least one flange.

An embodiment described herein provides a system. The system comprises one or more memory modules and one or more hardware processors communicably coupled to the one or more memory modules. The one or more hardware processors is configured to execute instructions stored on the one or more memory models to perform operations. The operations include obtaining sensor data associated with at least one flange, wherein the sensor data is captured by at least one sensor communicatively coupled with an embedded device on a mesh network. The operations include executing a trained tiny machine learning model at the embedded device, wherein the sensor data is input to the trained tiny machine learning model and the trained tiny machine learning model predicts a state of the at least one flange. The operations include transmitting the state to a master node across the mesh network, wherein further actions are performed responsive to the state of the at least one flange.

In some embodiments, the tiny trained machine learning model is built from a machine learning model trained using a training dataset comprising raw sensor data and synthesized sensor data.

In some embodiments, the further actions comprise an inspection of the at least one flange.

In some embodiments, the master node comprises a machine learning algorithm that is retained using sensor data from embedded devices on the mesh network, wherein the retrained machine learning algorithm is used to update the trained tiny machine learning model.

In some embodiments, wherein the master node controls the embedded device using commands propagated from the master node, to a root node, and to a node comprising the embedded device.

In some embodiments, the state of the at least one flange is normal or abnormal.

In some embodiments, the state of the flange is a probability distribution that one or more abnormalities is present.

### BRIEF DESCRIPTION OF DRAWINGS

FIG. 1 is an illustration of coupled flanges.

FIG. 2 is a diagram of a workflow that enables detection of abnormalities in flanges using embedded devices and tiny machine learning.

FIG. 3A shows a system architecture that enables detection of abnormalities in flanges using embedded devices and tiny machine learning.

FIG. 3B shows a mesh network topology.

FIG. 4 is a process flow diagram of a process enables detection of abnormalities in flanges using embedded devices and tiny machine learning.

FIG. 5 is a schematic illustration of an example controller (or control system) for detection of abnormalities in flanges using embedded devices and tiny machine learning according to the present disclosure.

### DETAILED DESCRIPTION

Flanges enable connections between pipes of pipeline systems that transport various materials, such as oil, gas, water, and the like. Additionally, flanges can securely seal pressurized vessels that store various materials. In examples, the term flange refers to a protruded ridge, lip, rim, or collar, either external or internal, which serves to increase strength. In examples, the flange enables attachment/transfer of contact force with another object or for stabilizes and guides the movements of a machine or its parts. Multiple flanges are used to create a flange joint, where two flange collars are bolted together using a set of bolts mated with corresponding nuts. A seal is created between the flange collars, enabling a strong joint or connection between two pipes. Ensuring the integrity of flanges and flange joints enables a safe pipeline or pressurized vessel. Flange abnormalities can cause leakage at the flange, resulting in danger to life and property, field shutdowns, and a loss of resources.

Embodiments described herein enable detection of abnormalities in flanges. In particular, the present techniques use embedded devices and tiny machine learning to detect abnormalities. In examples, abnormalities include, for example, missing bolt(s), misalignment, and flow blockage. One or more sensors are used in conjunction with trained machine learning models to predict abnormalities in flanges. Specifically, the data received from the one or more sensors is processed and input to an artificial intelligence (AI) powered algorithm such as neural network to predict abnormalities in one or more flanges. In some embodiments, the AI-algorithm is trained on annotated data of both normal and abnormal flanges.

Some advantages of the present techniques are the generation of continuous, real-time data that is used to predict abnormalities. Traditionally, inspections of flanges in the field are conducted infrequently, since traditional inspections require that a trained inspector travel to the pipeline and visually inspect the flanges. Additionally, once on-site, in traditional inspections the inspector may find that flanges are located in difficult to view or hidden locations due to the design of the pipeline. The predictions according to the present techniques enable a higher granularity of information associated with flanges, including difficult to reach flanges. Further, the predictions are made without reliance on inexperienced inspectors. Inexperienced inspectors are often unable to properly evaluate conditions of the flanges in traditional inspections. The present techniques predict abnormalities without inspector input, eliminating extensive, costly, and time consuming training of inspectors in order to evaluate flanges. Based on the prediction, flanges are repaired or replaced to ensure a safe and reliable system.

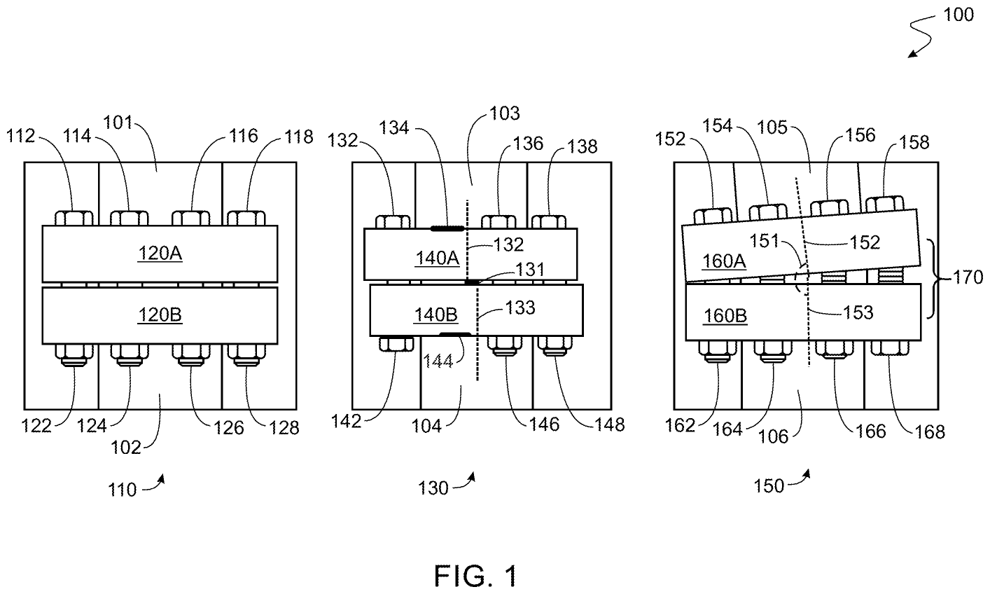

FIG. 1 is an illustration of coupled flanges 100. In some embodiments, the coupled flanges 100 are included in a pipeline system. For example, the pipeline system can be a gathering system, transmission system, or and distribution system with multiple flanges forming joints or connections across pipes of the pipeline. The flanges are often under high pressure and can transport hazardous or flammable material. Accordingly, flanges in poor condition can create a dangerous environment. The present techniques enable detection of abnormalities in flanges using embedded devices and tiny machine learning. The detections are used to inform repair or maintenance operations at the pipeline system. In examples, depending on the detected abnormality, repair or maintenance of the flange is performed. For example, loose bolts are tightened, missing or short bolts are replaced. Additionally, flanges are re-aligned or adjusted in response to the detected abnormalities.

In the example of FIG. 1, the coupled flanges 100 include a first coupled flange pair 110, a second coupled flange pair 130, and a third coupled flange pair 150. The first coupled flange pair 110 includes a number of bolts 112, 114, 116, and 118. The bolts extend through bolt holes in collars 120A and 120B of the coupled flange pair 110. A number of nuts 122, 124, 126, and 128 receive the threaded end of the bolts 112, 114, 116, and 118. Tightening the nuts 122, 124, 126, and 128 secures the collars 120A and 120B of the coupled flange pair 110, creating a seal between pipe 101 and pipe 102. A flange gasket (not illustrated) is placed between the collars 120A and 120B to create a seal.

In the example of FIG. 1, the second coupled flange pair 130 includes a number of bolts 132, 136, and 138. The bolts extend through bolt holes in collars 140A and 140B of the coupled flange pair 130. A number of nuts 142, 146, and 148 receive the threaded end of the bolts 132, 136, and 138. The nuts 142, 146, and 148 are threaded onto respective bolts 132, 136, and 138.

The coupled flange pair 130 shows abnormalities. In examples, an abnormality refers to a state of a flange that deviates from a normal or usual state that enables a proper seal at the flange. Additionally, an abnormality may refer to a state of a flange that is outside of limits associated with standards or other regulations that dictate proper flange states. Standards or regulations can include standards promulgated by organizations such as the American Society of Mechanical Engineers (ASME) and American National Standards Institute (ANSI). In examples, abnormalities include short/missing bolts, misalignment, loose/untightened flange, incorrect gasket type, missing gasket, misplaced gasket, a change in process fluid (flow or pressure) characteristics, and the like.

A short bolt abnormality is illustrated using bolt 132 and nut 142. In examples, a machine learning model predicts a state of a flange as having a short bolt. The short bolt abnormality is indicated by the bolt 132 being short and failing to extend fully through bolt holes of the collar 140A and the collar 140B. At bolt holes 134 and 144, a missing bolt defect is illustrated. In examples, a machine learning model predicts a state of a flange as having a missing bolt. A missing bolt abnormality is indicated by bolt holes without bolts, and reduces the integrity of the coupled flange collar 140A and the collar 140B. The collars 140A and 140B of the coupled flange pair 130 show a misalignment abnormality. In particular, the collar 140A and collar 140B show a parallel misalignment, which is indicated by an offset 131 between a centerline 135 of the collar 140A and a centerline 133 of the collar 140B. In examples, a machine learning model predicts a state of a flange as having a parallel misalignment.

The third coupled flange pair 150 includes a number of bolts 152, 154, 156, and 158. The bolts extend through collars 160A and 160B of the third coupled flange pair 150. A number of nuts 162, 164, 166, and 168 receive the threaded end of the bolts 152, 154, 156, and 158. The nuts 162, 164, 166, and 168 are threaded onto respective bolts 152, 154, 156, and 158. The coupled flange pair 150 shows abnormalities. For example, the collars 160A and 160B of the coupled flange pair 150 show a misalignment abnormality. In particular, the collar 160A and collar 160B show an angular misalignment, which is indicated by an angle 151 between a centerline 155 of the collar 160A and a centerline 153 of the collar 160B. In examples, a machine learning model predicts a state of a flange as having an angular misalignment. Additionally, the collar 160A and collar 160B show a loose/untightened abnormality, which is indicated by a large gap 170 between the collar 160A and the collar 160B. In examples, a machine learning model predicts a state of a flange as being loose or untightened. For ease of illustration, particular abnormalities are shown on a single coupled flange pair. However, a flange pair can exhibit one or more abnormalities, either alone or in combination. A single flange or a flange pair can exhibit any number of abnormalities. Additionally, for ease of description, the abnormalities in FIG. 1 are shown as visually observed by the human eye. However, in some embodiments, abnormalities associated with the coupled flanges are small and slight as to not be visible to the human eye.

For ease of description, the flanges described herein are include flange collars and a number of bolts. However, the flanges can be of many different types, such as Weld Neck Raised Face (WNRF), Socket Weld (SW), Slip-On Flange, Flat Faced (FF), Lap Joint, Ring Joint, Threaded Flange, Reducing Flange, Blind Flange, and the like. Face types of the flanges include, for example, flat face, raised face, ring joint face, tongue and groove, and male and female faces. Additionally, in examples, the flanges can include a number of finishes, such as serrated or smooth. In examples, a machine learning model predicts a state of a flange as having structural damage or damage to the finish of the flange.

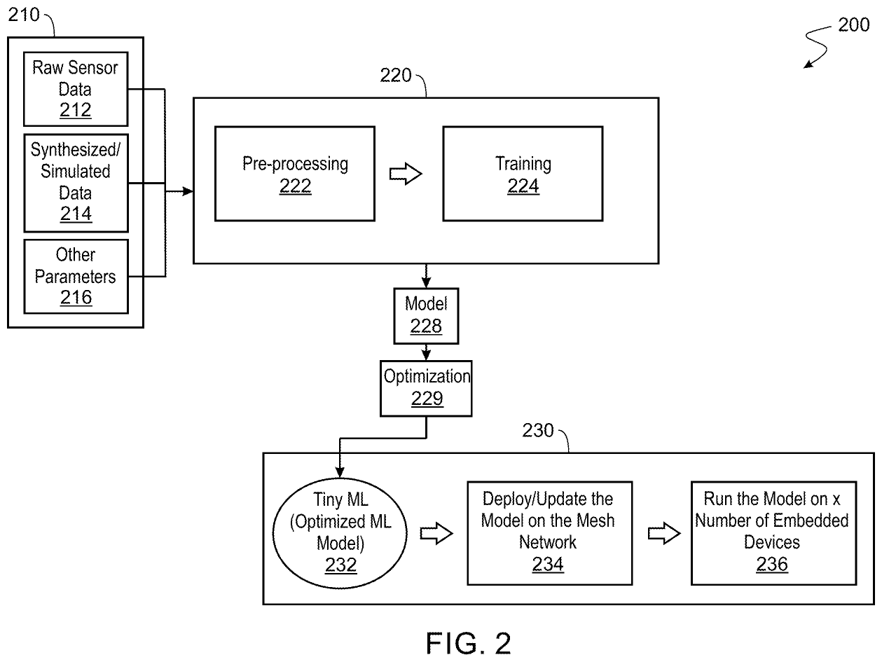

FIG. 2 is a diagram of a workflow 200 that enables detection of abnormalities in flanges using embedded devices and tiny machine learning. The workflow 200 uses inputs 210 to build a trained machine learning model 228 via a model building process 220. The inputs 210 include raw sensor data 212, synthesized/simulated data 214, and other parameters 216. The raw sensor data 212, synthesized/simulated data 214, or other parameters 216 are used to form a training dataset that is used to train a machine learning model in the model building process 220. In examples, raw sensor data 212 is captured using one or more sensors are mounted on the flange. For example, the sensors are mounted on the body of the flange, such as on the collar of the flange. In examples, sensors are mounted near the flange. For example, sensors are mounted on the upstream and downstream portions of pipe coupled using a flange. In an example, identical sensors (e.g., sensors of the same type) or sensors with a known relationship are mounted upstream and downstream of the flange or flange pair, and differentials between the identical sensors is used to train the machine learning model or make predictions on the state of the flange.

The sensors include, for example, vibration sensors, acoustic sensors, accelerometers, high-speed cameras, gyroscopes, ultrasonic sensors, temperature sensors, and the like. One or a combination of sensors is used to capture data associated with flanges. Data captured by the sensors is used to learn signatures or patterns in the sensor data associated with abnormalities. In examples, the high-speed cameras located near flanges capture images of the flanges that are used for motion magnification. Motion magnification amplifies subtle motions in a video sequence, enabling visualization of deformations that would otherwise be invisible.

In some embodiments, the raw sensor data 212 is captured using various pipeline parameters including healthy, normal flanges under normal operating conditions and flanges with at least one abnormality. In some embodiments, the raw sensor data is labeled according to the state of a respective flange when the raw sensor data is captured. The labels are a binary classification (e.g., normal, abnormal) of the flange state. In some examples, the labels are a probability distribution that one or more states is present.

In some embodiments, the raw sensor data 212 is captured exclusively from healthy, normal flanges normal operating conditions. As a result, a machine learning model is trained using sensor data that corresponds to healthy operational conditions of the flange. A machine learning model trained using sensor data that corresponds to healthy operational conditions of the flange predicts if a flange is normal, and any divergence from that normal is an abnormality.

The inputs 210 also include synthesized/simulated data 214. Synthesized/simulated data is used to expand a dataset for training the machine learning model. Training the machine learning model using a larger, expanded dataset increases an accuracy of detections made by the trained machine learning model. Acquiring sensor data associated with abnormal flanges can be challenging when compared with acquiring sensor data associated with normal flanges. The synthesized/simulated data can represent edge cases or dangerous cases that do not occur frequently in the real world, resulting in a lack of sensor data representing the edge cases. Edge cases or dangerous cases are, for example, blowouts, leakage, or other failures of the flange. Synthesizing sensor data results in a more robust machine learning model that can detect both normal and abnormal flanges. To generate synthesized/simulated data, an auto-encoder or other unsupervised learning technique for a neural network learns efficient data representations (e.g., encoding) by training a neural network to ignore signal noise.

The inputs 210 also include the other parameters 216. The other parameters 216 enable greater generalization by the machine learning model. The other parameters include, for example, a pipe diameter, pipe material of construction (MOC), service fluid, process parameters (flow, pressure, temperature, etc. process parameters), ambient conditions (e.g., ambient temperature, humidity, etc.), flange orientation (e.g., vertical or horizontal), and other degradations (e.g., material loss, paint damage, etc.). In examples, the other parameters include details about the flange joint, which includes flange size and rating (e.g. size in inch diameter with pressure rating in pounds: gasket type, flange type, process fluid in the subject along with characteristics like pressure/flow/temperature etc.). In some embodiments, a training dataset including the raw sensor data 212 and/or synthesized/simulated data is annotated based on other parameters 216, including the parameters associated with the pipeline and the flange. These other parameters can improve the accuracy of the model. In examples, the other parameters are directly and automatically added to the training dataset using a same sensor on a respective embedded device. In examples, the same sensor is a temperature sensor, pressure sensor, humidity sensor, or flowmeter sensor. In examples, the same sensor data is measured or acquired using a central processing unit.

To train a machine learning model 228, the model building process includes preprocessing 222 and training 224. The model building process obtains a training dataset that includes one or more of the inputs 210 and outputs a trained machine learning model 228. Pre-processing 222 extracts features from the raw sensor data 212. In examples, the raw sensor data 212 is time series data, such as vibrations of a flange captured by a vibration sensor on or near the flange. Pre-processing the time series data cleans the data by checking for missing values, noisy data, and other inconsistencies, thereby easing the training of the machine learning model and producing a more accurate trained machine learning model. In examples, pre-processing 222 includes applying Fourier Transforms, Power Transforms, Normalization, Difference Transform, and standardization to the training dataset. At training 224, the pre-processed training dataset is used to train a machine learning algorithm such a neural network, a convolutional neural network, or recurrent neural network. The machine learning algorithm is trained to predict abnormalities of flanges based on the other parameters and pre-processed data from the sensor. In examples, signal detection using attention transformers is used to detect abnormality signatures. The attention transformer is a neural network that uses self-attention mechanisms to process training data. The attention transformer determines the importance of the training data in the dataset in predicting the output, thereby focusing on the most relevant parts of a training dataset when generating an output. In some embodiments, the machine learning algorithm is based on a transformer architecture that enables capture of long-term dependency of the signal, and the transformer architecture focuses on the part of input that maximizes the correct output.

The model building process 220 results in a trained machine learning model 228 that predicts abnormalities of a flange. In examples, the model building process includes testing, validation, or verification of the machine learning model to generate the trained machine learning model 228. In some embodiments, unseen input data including unseen raw sensor data or other parameters associated with a respective flange are input to the trained machine learning model, and the trained machine learning model outputs a binary classification (e.g., normal, abnormal) associated with the respective flange. In some examples, the trained machine learning model outputs a probability distribution of one or more abnormalities being present at one or more flanges.

In examples, the trained machine learning model 228 is input to optimization 229. The optimization 229 transforms the trained machine learning model 228 for execution on an embedded device resulting in a trained tiny machine learning model 232. As shown in FIG. 2, the trained tiny machine learning model is used in inference 230. In inference 230, the model is installed in a low-power embedded device. In examples, the embedded device is permanently placed on or near a flange or flange joint. Downsizing and quantizing the machine learning model 228 using tiny machine learning techniques enables deployment of the tiny machine learning model 230 on microcontrollers and similar low-power devices. In some embodiments, the trained machine learning model 228 executes on a remote computer, and raw sensor data is captured and transmitted to the remote computer that is capable of more advanced processing. In some embodiments, the trained machine learning model 228 is used for inference 230 on the remote computer.

As shown in FIG. 2, the trained tiny machine learning model 232 is optimized (e.g., optimization 229) for deployment on resource-constrained devices, such as microcontrollers or low-power embedded devices. The trained tiny machine learning model 232 is lightweight with a small memory and computation footprint when compared to unconstrained machine learning models (e.g., trained machine learning model 228). In examples, the trained tiny machine learning model 232 is generated from the trained machine learning model 228 through optimization 229 that includes quantization and pruning to reduce the size of model parameters. In some examples, the trained tiny machine learning model 232 executes using hardware accelerators, including dedicated inference chips, to improve the inference speed with low power consumption. In quantization, the weights are converted from float to integer values, which reduces the size of the machine learning model. Pruning cuts or removes weights that do not substantially contribute to the output of the model.

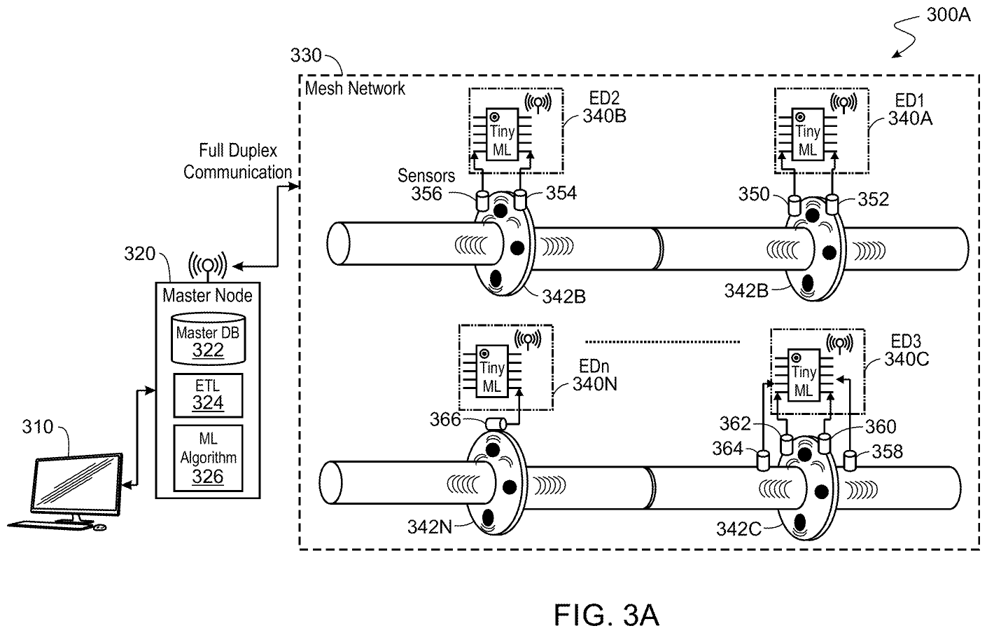

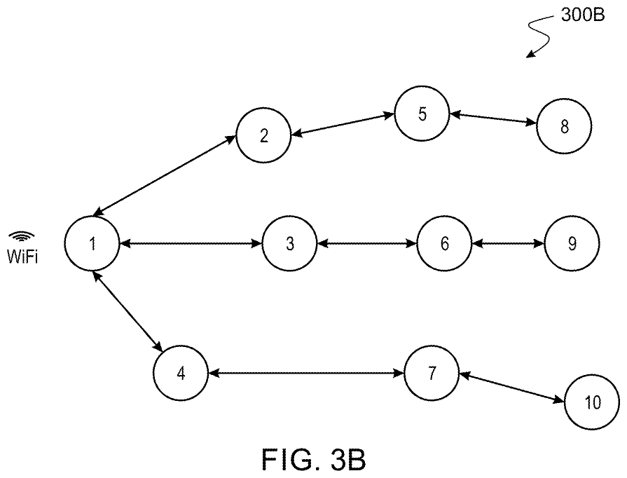

In inference 230, the trained tiny machine learning model 232 is deployed or updated (e.g., 234) on a mesh network. Deployment refers to the process of implementing a fully functioning machine learning model into production where it can make detections based on unseen data. In examples, deployment refers to updating an existing machine learning model on the mesh network. The updates occur, for example, when additional training data is available or responsive to data drift (e.g., the statistical properties of the target variable, which the model is trying to predict, has changed over time). Additional training data results in better accuracy of the trained models. In some embodiments, the optimized model is executed on a predetermined number of embedded devices (e.g., 236). By having multiple sensors or devices permanently installed on the flanges, the additional data improves the accuracy of the trained model. Deployment/updating the machine learning model is further described with respect to FIG. 3A-3B.

In inference 230, the trained tiny machine learning model 232 executes at a respective embedded device of the mesh network. Each embedded device of a mesh network captures sensor data from sensors deployed at or near a respective flange.

The embedded devices are communicatively coupled and enable communication between the embedded devices on the mesh network and external networks and devices. The sensors associated with flanges communicate and relay detections. In some embodiments, the mesh network enables a decentralized model, where each trained tiny machine learning model 232 executes on an embedded device of the network and detects abnormalities based on the unseen sensor data or other parameters. In some embodiments, the mesh network enables a centralized model, unseen sensor data is transmitted to a remote computer (e.g., a device on a network other than the mesh network) using respective embedded devices of the mesh network, and a full-sized, trained machine learning model (e.g., output machine learning model 228) detects abnormalities based on the unseen sensor data or other parameters at the remote computer.

In examples, the detection based on the unseen sensor data is used to identify any abnormal operation of the flange so that inspections or other corrective actions are performed. Using the trained machine learning models results in improvements to flange abnormality detection by predicting abnormalities prior to the occurrence of a failure at the flange. When sensor data results in an abnormal flange prediction, further inspections of the flange are triggered. The further inspections can be manual inspections performed by humans at the flange or further review of the captured sensor data. In examples, the captured sensor data is transformed into a prediction of normal or abnormal flange states. When sensor data results in an abnormal flange prediction, fluid flow at the flange or other use of the flange is halted in a controlled manner to enable corrective actions and or further inspection. Ultimately, flange functionality is improved through the predictions that give insight into the state of respective flanges.

The trained machine learning model 228 and trained tiny machine learning model 232 enable generalization and adapt to new, previously unseen data, drawn from the same distribution as the training dataset. In examples, even when trained exclusively on raw sensor data, the trained machine learning model 228 and trained tiny machine learning model 232 are generalized an adapt to the new, previously unseen data. In examples, the trained tiny machine learning models execute via respective embedded devices on a mesh network, and the weights of the trained tiny machine learning models are the same at each respective embedded device. The inputs of the other parameters vary at each respective embedded device. In some embodiments, a specialized machine learning model is built for a specific flange by training a machine learning model using data obtained from the specific flange. In this case, this specialized machine learning model obtains as input unseen data captured by sensors associated with the specific flange.

FIG. 3A shows a system architecture 300A that enables detection of abnormalities in flanges using embedded devices and tiny machine learning. In the example of FIG. 3A a computer system 310 enables communication with a master node 320. The master node 320 is in full duplex communication with a mesh network 330.

In the example of FIG. 3A, the master node includes a master database 322, an extract, transform, and load (ETL) block 324 and a machine learning algorithm 326. The ETL block 324 is a data integration process that combines data from multiple data sources into a single, consistent data store such as the master database 322. The master database 322 stores detailed information about each node in the network such as location, flange size, tag number, machine learning model version, etc. The master database 322 also stores collected data from the sensors at each flange to train and update a new model and historical detections of flanges in the network. The master node 320 includes a machine learning algorithm 326. In some embodiments, the machine learning algorithm 326 is the same as or similar to the trained machine learning model 228 of FIG. 2. In some embodiments, the machine learning algorithm 326 operates in a centralized model, where the machine learning algorithm 326 obtains the data from the embedded devices (e.g., sensors 350, 352, 354, 356, 358, 360, 362, 364, and 366) and predicts flange abnormalities. In some embodiments, the data from the embedded devices is used to retrain the machine learning algorithm 326 to improve the performance or accuracy of the machine learning algorithm 326.

In some embodiments, the machine learning algorithm 326 operates in a decentralized model, where each embedded device has its own trained tiny machine learning model. In a decentralized model, there is no relationship between the machine learning algorithm 326 and the trained tiny machine learning models at each embedded device. However, the master node 320 is used to control and propagate information through the mesh network in the decentralized model. The tiny trained machine learning models at each embedded device are updated and tested, the master node 320 propagates the updated models through the mesh network 330.

The mesh network 330 includes embedded device 340A, embedded device 340B, embedded device 340C . . . and embedded device 340N. As shown in FIG. 3A, a trained tiny machine learning model is located at each embedded device, and each embedded device is associated with a flange. The trained tiny machine learning model at each embedded device may be the trained tiny machine learning model 232 described with respect to FIG. 2. In examples, an embedded device is permanently installed on a flange. In examples, the embedded device is permanently installed on the flange during manufacture of the flange. In examples, the embedded device is permanently installed on the flange after manufacture of the flange. In examples, an embedded device is removably installed on a flange during manufacture of the flange. In examples, an embedded device is removably installed on a flange after manufacture of the flange. In examples, the sensors are configured in a pairwise configuration as shown by sensors 350/352 and 354/356. In a pairwise sensor configuration, a first sensor is positioned in the upstream flow with respect to the flange, and the second sensor is positioned in the downstream flow with respect to the flange. Using at least two sensors positioned in the upstream and downstream flow, differential sensor data associated with the flange is obtained. For example, when the pairwise sensor configuration includes two accelerometers or other vibration sensors, the differential vibration from flow within the pipes before and after the flange is obtained. In some embodiments, the differential sensor data is used to train and predict flange abnormalities.

For ease of illustration, a fixed number of embedded devices and flanges are illustrated. However, the mesh network 330 can include any number of embedded devices associated with at least one flange. As shown in FIG. 3A, the embedded device 340A processes data associated with flange joint 342A, the embedded device 340B processes data associated with flange joint 342B, the embedded device 340C processes data associated with flange joint 342C, and the embedded device 340N processes data associated with flange joint 342N. For ease of illustration, FIG. 3A shows embedded devices associated with flange joints that include a pair of physically coupled flange collars. However, the embedded devices can be associated with a single flange collar. As shown in FIG. 3A, each embedded device is communicatively coupled with one or more sensors. The embedded device 340A is communicatively coupled with sensors 350 and 352, the embedded device 340B is communicatively coupled with sensors 354 and 356, the embedded device 340C is communicatively coupled with sensors 358, 360, 362, and 364, and the embedded device 340N is communicatively coupled with sensor 366. In some embodiments, the trained tiny machine learning model at each respective flange joint is fine-tuned based on the available sensor data at the respective flange. For example, a trained tiny machine learning model at a respective flange is trained using data captured by sensors associated with the respective flange to obtain an increased accuracy of predictions. In some embodiments, a machine learning model is fine-tuned based on data similar to the flange environment where sensor data to be input to the machine learning model is captured as opposed of training using sensor data from various sources.

The embedded device 340A, embedded device 340B, embedded device 340C, and embedded device 340N capture sensor data associated with respective flanges and transmit the sensor data using the mesh network 330. In some embodiments, the mesh network 330 is an IPV6-based network. In examples, the mesh network 330 is an OpenThread network (e.g., 802.15.4 Thread) that routes data from one or more embedded devices that form the mesh. In examples, the mesh network 330 is a Matter network as provided by the Connectivity Standards Alliance. In examples, the mesh network 330 is a Bluetooth Low Energy (LE) network as provided by the Bluetooth Special Interest Group. In examples, the mesh network 330 is a Bluetooth mesh network as provided by the Bluetooth Special Interest Group. In examples, the mesh network 330 is a Zigbee network as provided by the Connectivity Standards Alliance. In examples, the network 330 is an ANT Network as provided by the ANT+ Alliance.

FIG. 3B shows an exemplary mesh network topology 300B. In examples, each embedded device (e.g., embedded devices 340A, 340B, 340C, . . . , 340N) corresponds to a node of the mesh network. Nodes are shown by numbered circles in the mesh network topology 300B. The edges represent communication paths between the nodes and are shown by lines and arrows connecting the nodes. The mesh network configuration enables connection to an outside network at a single node of the mesh network. In the example of FIG. 3B, node 1 is connected to an external network using a Wi-Fi connection. While node 1 is connected to the external network (e.g., the Internet) through Wi-Fi and considered the root node of the network, the remaining nodes are connected to the external network using communication paths that include the closest node in the pre-determined mesh network topology. In some embodiments, each node of the mesh network is Wi-Fi capable (e.g., include hardware to connect to the external network), however a single node is connected to the external network. In some embodiments, the root node enables communication between an IPV4 network (e.g., the Internet) and the mesh network 330. The root node is positioned at an edge of the mesh network 330, and in some embodiments, the root node routes data between the mesh network 330 and an external network, such as the Internet.

Each node/embedded device is a separate device with its own unique trained tiny machine learning model that executes independently of other nodes/embedded devices. Information is relayed along the communication paths (e.g., edges) to the root node connected to the external network. For example, when a trained tiny machine learning model predicts a normal or abnormal flange, the information is transmitted across the mesh network to the external network. For example, in FIG. 3B a prediction of abnormal flange occurs at node 9, and is propagated down the sequence node 9→node 6→node 3→node 1→WiFi/INTERNET.

As shown in FIG. 3B, communication between the two nodes is a two-way communication as indicated by bi-directional edges. This enables communications to and from each node according to a predetermined communication protocol. For example, updates or other information is transmitted to any node starting with the root node that is connected to an external network. In some embodiments, the root node can receive updates for one or more nodes over the air. In some embodiments, the communications to and from nodes include pre-programmed commands to shut down respective nodes, put them to sleep, or have them request information from their neighboring nodes. In examples, conveying and sharing information using a neighboring node is a command that requests neighboring node to relay the information and propagate it downward to the root node. For each command, there are predetermined certain conditions that are to be met before execution. For example, a node should not be shut down if the node is the only means of reaching a certain cluster or other nodes of the network.

Referring again to FIG. 3A, a trained tiny machine learning model (e.g., trained tiny machine learning model 232 of FIG. 2) is deployed or updated on one or more embedded devices in a mesh network. In some embodiments, the trained tiny machine learning models are updated by updating and optimizing the machine learning algorithm 326 on the master node. Then, updates are sent from the master node 320 through the mesh network 330 to the targeted group of embedded devices. Such a training and updating scheme is a centralized training and distribution of a machine learning model.

In some embodiments, the root node of the mesh network enables full duplex communication with the master node 320. The root node of the mesh network 330 is communicatively coupled to a master node 320. The root node transmits sensor data to the master node 320, and the master node 320 to the computer system 310. In examples, the computer system 310 is a tablet computer, cellular phone, laptop, or other mobile electronic device. In examples, the computer system 310 is connected on the IPV4 network and acts as a user interface for interactions with embedded devices of the mesh network 330. For example, the computer system 310 can send configuration updates to the embedded devices.

In some embodiments, the tiny machine learning models process respective sensor data locally at its corresponding embedded device transmitting it to the master node 320 via a root node of the mesh network. In some embodiments, the embedded devices transmits data to the master node 320 for processing. Thus, the predictions can be made locally within the mesh network or at a remote location, such as at the master node 320 or computer system 310.

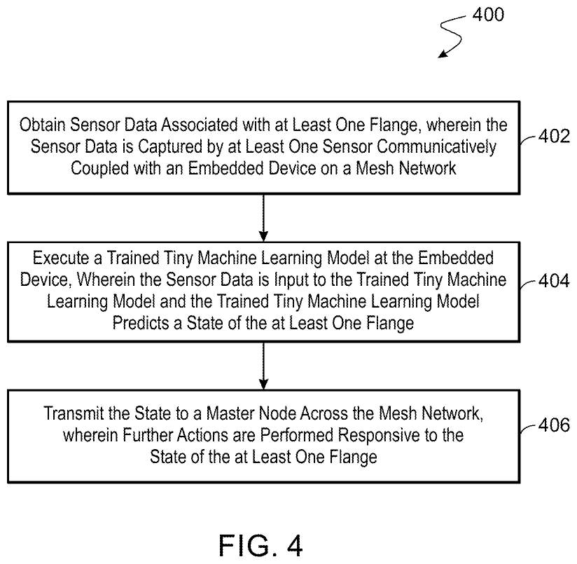

FIG. 4 is a process flow diagram of a process that enables detection of abnormalities in flanges using embedded devices and tiny machine learning. In some embodiments, the machine learning models are trained as described with respect to FIGS. 3 and 4. The present techniques introduce a systematic and automated procedure to assess the integrity of flanges.

At block 402, sensor data associated with at least one flange is obtained, wherein the sensor data is captured by at least one sensor communicatively coupled with an embedded device on a mesh network.

At block 404, a trained tiny machine learning model is executed at the embedded device, wherein the sensor data is input to the trained tiny machine learning model and the trained tiny machine learning model predicts a state of the at least one flange. In examples, the tiny trained machine learning model is built from a machine learning model trained using a training dataset comprising raw sensor data and synthesized sensor data. The state of the at least one flange may be, for example, normal or abnormal. Additionally, the state of the flange may be a probability distribution that one or more abnormalities is present.

At block 406, the state is transmitted to a master node across the mesh network, wherein further actions are performed responsive to the state of the at least one flange. In examples, the further actions comprise an inspection of the at least one flange. Additionally, in examples the master node comprises a machine learning algorithm that is retained using sensor data from embedded devices on the mesh network, wherein the retrained machine learning algorithm is used to update the trained tiny machine learning model.

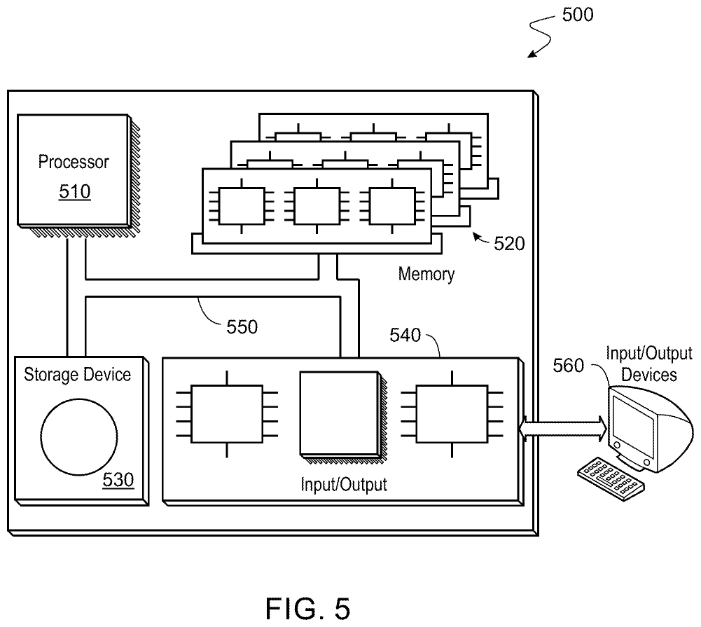

FIG. 5 is a schematic illustration of an example controller 500 (or control system) for flange integrity classification using artificial intelligence according to the present disclosure. For example, the controller 500 may be operable according to the workflow 200 of FIG. 2, the process 400 of FIG. 4, or any combinations thereof. Additionally, the controller 500 may be operable within the system architecture 300A of FIG. 3A, the mesh network topology 300B of FIG. 3B, or any combinations thereof. The controller 500 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 500 includes a processor 510, a memory 520, a storage device 530, and an input/output interface 540 communicatively coupled with input/output devices 560 (for example, displays, keyboards, measurement devices, sensors, valves, pumps). Each of the components 510, 520, 530, and 540 are interconnected using a system bus 550. The processor 510 is capable of processing instructions for execution within the controller 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output interface 540.

The memory 520 stores information within the controller 500. In one implementation, the memory 520 is a computer-readable medium. In one implementation, the memory 520 is a volatile memory unit. In another implementation, the memory 520 is a nonvolatile memory unit.

The storage device 530 is capable of providing mass storage for the controller 500. In one implementation, the storage device 530 is a computer-readable medium. In various different implementations, the storage device 530 may be a floppy disk device, a hard disk device, an optical disk device, or a tape device.

The input/output interface 540 provides input/output operations for the controller 500. In one implementation, the input/output devices 560 includes a keyboard and/or pointing device. In another implementation, the input/output devices 560 includes a display unit for displaying graphical user interfaces.

There can be any number of controllers 500 associated with, or external to, a computer system containing controller 500, with each controller 500 communicating over a network. Further, the terms “client,” “user,” and other appropriate terminology can be used interchangeably, as appropriate, without departing from the scope of the present disclosure. Moreover, the present disclosure contemplates that many users can use one controller 500 and one user can use multiple controllers 500.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a

program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/-R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method: a non-transitory, computer-readable medium storing computer-readable instructions to perform the computer-implemented method: and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method for detection of flange abnormalities, the method comprising:
obtaining, with one or more hardware processors, sensor data associated with at least one flange, wherein the sensor data is captured by at least one sensor communicatively coupled with an embedded device on a mesh network;
executing, with the one or more hardware processors, a trained tiny machine learning model at the embedded device, wherein the sensor data is input to the trained tiny machine learning model and the trained tiny machine learning model predicts a state of the at least one flange; and
transmitting, with the one or more hardware processors, the state to a master node across the mesh network, wherein further actions are performed responsive to the state of the at least one flange.

2. The computer implemented method of claim 1, wherein the tiny trained machine learning model is built from a machine learning model trained using a training dataset comprising raw sensor data and synthesized sensor data.

3. The computer implemented method of claim 1, wherein the further actions comprise an inspection of the at least one flange.

4. The computer implemented method of claim 1, wherein the master node comprises a machine learning algorithm that is retained using sensor data from embedded devices on the mesh network, wherein the retrained machine learning algorithm is used to update the trained tiny machine learning model.

5. The computer implemented method of claim 1, wherein the master node controls the embedded device using commands propagated from the master node, to a root node, and to a node comprising the embedded device.

6. The computer implemented method of claim 1, wherein the state of the at least one flange is normal or abnormal.

7. The computer implemented method of claim 1, wherein the state of the flange is a probability distribution that one or more abnormalities is present.

8. An apparatus comprising a non-transitory, computer readable, storage medium that stores instructions that, when executed by at least one processor, cause the at least one processor to perform operations comprising:
obtaining sensor data associated with at least one flange, wherein the sensor data is captured by at least one sensor communicatively coupled with an embedded device on a mesh network:
executing a trained tiny machine learning model at the embedded device, wherein the sensor data is input to the trained tiny machine learning model and the trained tiny machine learning model predicts a state of the at least one flange; and
transmitting the state to a master node across the mesh network, wherein further actions are performed responsive to the state of the at least one flange.

9. The apparatus of claim 8, wherein the tiny trained machine learning model is built from a machine learning model trained using a training dataset comprising raw sensor data and synthesized sensor data.

10. The apparatus of claim 8, wherein the further actions comprise an inspection of the at least one flange.

11. The apparatus of claim 8, wherein the master node comprises a machine learning algorithm that is retained using sensor data from embedded devices on the mesh network, wherein the retrained machine learning algorithm is used to update the trained tiny machine learning model.

12. The apparatus of claim 8, wherein the master node controls the embedded device using commands propagated from the master node, to a root node, and to a node comprising the embedded device.

13. The apparatus of claim 8, wherein the state of the at least one flange is normal or abnormal.

14. The apparatus of claim 8, wherein the state of the flange is a probability distribution that one or more abnormalities is present.

15. A system, comprising:
one or more memory modules:
one or more hardware processors communicably coupled to the one or more memory modules, the one or more hardware processors configured to execute instructions stored on the one or more memory models to perform operations comprising:
obtaining sensor data associated with at least one flange, wherein the sensor data is captured by at least one sensor communicatively coupled with an embedded device on a mesh network:
executing a trained tiny machine learning model at the embedded device, wherein the sensor data is input to the trained tiny machine learning model and the trained tiny machine learning model predicts a state of the at least one flange; and
transmitting the state to a master node across the mesh network, wherein further actions are performed responsive to the state of the at least one flange.

16. The system of claim 15, wherein the tiny trained machine learning model is built from a machine learning model trained using a training dataset comprising raw sensor data and synthesized sensor data.

17. The system of claim 15, wherein the further actions comprise an inspection of the at least one flange.

18. The system of claim 15, wherein the master node comprises a machine learning algorithm that is retained using sensor data from embedded devices on the mesh network, wherein the retrained machine learning algorithm is used to update the trained tiny machine learning model.

19. The system of claim 15, wherein the master node controls the embedded device using commands propagated from the master node, to a root node, and to a node comprising the embedded device.

20. The system of claim 15, wherein the state of the at least one flange is normal or abnormal.
